(19) United States
(12) Patent Application Publication
(10) Pub. No.: US 2004/0067414 A1
(43) Pub. Date: Apr. 8, 2004

(54) Thermal control device and method of use therefor

(76) Inventors: Ronghua Wei, San Antonio, TX (US); Leslie Momoda, Los Angeles, CA (US)

Correspondence Address: TOPE-MCKAY & ASSOCIATES, 23852 PACIFIC COAST HIGHWAY #311, MALIBU, CA, 90265, US

(21) Appl. No.: 10/263,926

(22) Filed: Oct. 2, 2002

(51) Int. Cl. H01M 2/02; F28F 3/08

(52) U.S. Cl. 429/166; 165/167

(57) ABSTRACT

The present invention provides a thermal management apparatus and method that yields a more homogeneous thermal distribution on a thermal plate and further, minimizes the pressure drop across a thermal plate. The invention includes a first plate 100 and a second plate 102. The plates includes fluid delivery channel 104a configured to deliver a fluid to a first fluid flow channel 106a. The first fluid flow channel 106a serves as a feeder for the first peripheral fluid distribution channels 108a. The cross sectional areas of the peripheral fluid distribution channels 108a can be constant or can be varied so as to ensure a constant heat flux across the plate per unit area.

### FIELD OF THE INVENTION

The present invention relates generally to heat exchangers and more specifically to a plurality of stacked heat exchangers, each having a high degree of thermal uniformity.

### BACKGROUND

Heat exchanger-based thermal management systems have a plurality of parameters that require optimization through careful design. The first such parameter is thermal homogeneity throughout the system. Thermal homogeneity is an important factor in many chemical reactions, including the reactions that occur within fuel cells. Increased temperature homogeneity and control typically results in more efficient fuel cell operation. The second parameter requiring optimization also relates to efficiency. Energy is consumed when the thermal control fluid is forced through the heat exchanger, resulting in reduced efficiency. This inefficiency manifests itself as a pressure drop across the heat exchanger. There is a direct correlation between pressure drop in the thermal management system and the energy required to move the thermal control fluid through the thermal management system. In general, the greater the length of the flow channel in the thermal management system, the greater the pressure drop. Following this corollary, the greater the pressure drop the more energy required to force the thermal control fluid through the heat exchanger, thus resulting in a loss of efficiency in the overall system.

Artisans have traditionally relied on a serpentine design for thermal control of fuel cell stacks. Because the channels employed are long, this design inevitably results in a non-trivial pressure drop. In addition, when utilizing the serpentine design, the fluid temperature varies in a consequentially meaningful manner from the fluid inlet port to the fluid outlet port, and there is an attendant thermal inhomogeneity introduced across the heat exchanger.

Alternative proposed solutions have included providing a flow channel design configured to minimize pressure drop and temperature variance. In this design the fluid comes in from the inlet port, is heated using a heating element in the center of the stack, and then exits at the outlet port. This design induces a thermal gradient across the cells at the center of the stack and those at the perimeter, thereby resulting in lessened performance.

It would therefore be desirable to provide a thermal management system configured to provide a substantially uniform temperature distribution across a surface area, and further, it would be desirable to simultaneously provide for a relatively low-pressure drop across the thermal management system.

### SUMMARY OF THE INVENTION

The present invention provides a thermal management system configured to provide a substantially uniform temperature distribution across a surface area, and further, simultaneously provides for a relatively low-pressure drop across the thermal management system. The term “thermal management system”, as used herein is essentially a heat exchanger, which is designed to achieve and maintain a plate temperature that is divorced from fluctuations in the time domain. One general embodiment provides for a plurality of successively layered plates. This architecture allows for the placement of fuel cells between the plates and provides a high degree of thermal homogeneity and thermal control. Another embodiment of the present invention provides a first plate which includes a fluid delivery channel configured to deliver a fluid to a first fluid flow channel. Further there are a plurality peripheral fluid distribution channels in this first plate, which are configured to receive fluid from the fluid flow channel and transport the fluid substantially from a first portion of the first plate to a second portion of the first plate and finally into a first used fluid flow channel and into a first used fluid return channel. Additionally there is a second plate which includes a fluid delivery channel configured to deliver a fluid to a second fluid flow channel. The second fluid flow channel feeds a plurality second peripheral fluid distribution channels that transport the fluid substantially from a second portion of the second plate to a first portion of the second plate and into a second used fluid flow channel. The second fluid flow channel provides the fluid to a used fluid return channel. In this embodiment the first and second plates are of substantially the same size and shape and are positioned for substantial overlap, and optionally allow for the placement of a device between said first plate and said second plate.

The invention also provides a thermal management method comprising the steps of providing a first plate, and introducing a thermal control fluid into a fluid delivery channel. The fluid may take any number of forms including gases and liquids. The next step includes providing the thermal control fluid to a first fluid flow channel at a first portion of the first plate. Next the thermal control fluid is forced into a plurality first peripheral fluid distribution channels, and toward a second portion of a first plate. The thermal control fluid is then directed into a used fluid flow channel. From the used fluid flow channel the thermal control fluid is compelled into a used coolant return channel. Additionally this embodiment of the invention includes providing a second plate and introducing a thermal control fluid into a fluid delivery channel and providing the thermal control fluid to a second fluid flow channel at a second portion of the second plate. This second portion physically corresponds with the second portion of the first plate, but the second plate itself has a different internal configuration and flow pattern as compared with the first plate. In the next step thermal control fluid is forced into a plurality peripheral fluid distribution channels and forced toward a first portion of a second plate. The thermal control fluid is directed into a used fluid flow channel and ultimately forced into the used coolant return channel.

### BRIEF DESCRIPTION OF THE DRAWINGS

The objects, features, and advantages of the present invention will be apparent from the following detailed description of the preferred embodiment of the invention with references to the following drawings:

FIG. 1 is a cross-sectional view depicting one embodiment of a heat exchanger plate with cooling channels;

FIG. 2 is a cross-sectional view depicting an alternative embodiment of the heat exchanger plate with cooling channels;

FIG. 3 is a cross-sectional view depicting four interconnected heat exchanger plates with cooling channels;

FIG. 4 is a cross-sectional view depicting a heat exchanger plate with cooling channel of a first embodiment;

FIG. 5 is a cross-sectional view depicting four heat exchanger plates with cooling channels according to a second embodiment; and

FIG. 6 is a flowchart showing the method steps according to one embodiment of the present invention.

### DETAILED DESCRIPTION

The present invention provides a thermal management apparatus and method that yields a more homogeneous thermal distribution on a thermal plate and further, minimizes the pressure drop of a thermal control fluid across a thermal plate. One general embodiment provides for a plurality of successively layered plates. The following description; taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

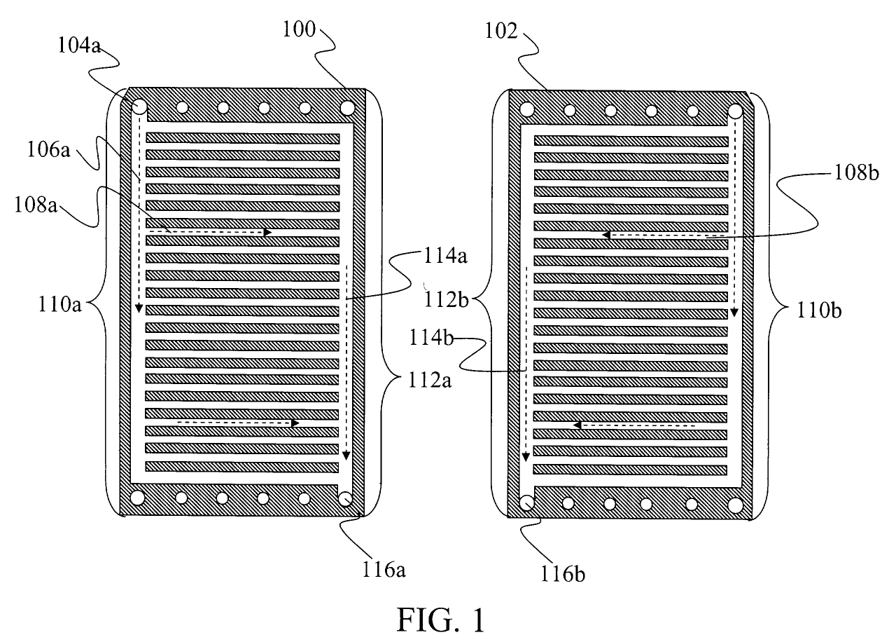

According to one embodiment, depicted in FIG. 1, this invention relates to an apparatus for improved thermal management. This thermal management apparatus comprises a first plate 100 and a second plate 102. The plates are a type of heat exchanger. In one embodiment the plates comprise a fluid delivery channel opening 104a of the first plate having a first cross sectional area. The fluid delivery channel opening 104a of the first plate is configured to deliver a fluid to a fluid flow channel 106a of the first plate. The fluid flow channel 106a of the first plate serves as a feeder for the plurality of peripheral fluid distribution channels 108a of the first plate. The cross sectional areas of the peripheral fluid distribution channels 108a can be constant or can be varied so as to ensure a constant heat flux across the plate, per unit area. When the cross sectional area of the peripheral fluid distribution channels 108a of the first plate is varied, the fluid delivery channel 104a of the first plate will generally have an cross sectional area greater than the aggregated cross-sectional areas of the peripheral fluid distribution channels 108a. The used fluid flow channel 114a of the first plate has a cross sectional area equal to or larger than that of the fluid delivery channel 104a of the first plate. Alternatively the peripheral fluid distribution channels 108a of the first plate, have a plurality of cross sectional areas configured such that the heat flux is substantially constant and uniform across the entire plate. In such an embodiment the channel cross sections are generally smallest most near the fluid delivery channel 104a and largest most near the used fluid return channel 116a. The size variations are adjusted to take into account variations in fluid temperature, flow speed and other parameters affecting heat flux.

In yet another embodiment the peripheral fluid distribution channels 108a nearest the fluid delivery channel opening 104a of the first plate are configured to receive fluid from the fluid flow channel 106a and transport the fluid from a first portion 110a of the first plate to a second portion 112a of the first plate and into the first used fluid flow channel 114a. Similarly, with the second plate 102, the fluid is transported from a second portion 110b of the second plate 102 to a first portion 112b of the second plate 102 and into a second used fluid flow channel 114b. The second used fluid flow channel 114b provides the fluid to a second used fluid return channel 116b having a fourth cross sectional area, and is configured to receive fluid from the second used fluid flow channel 114b.

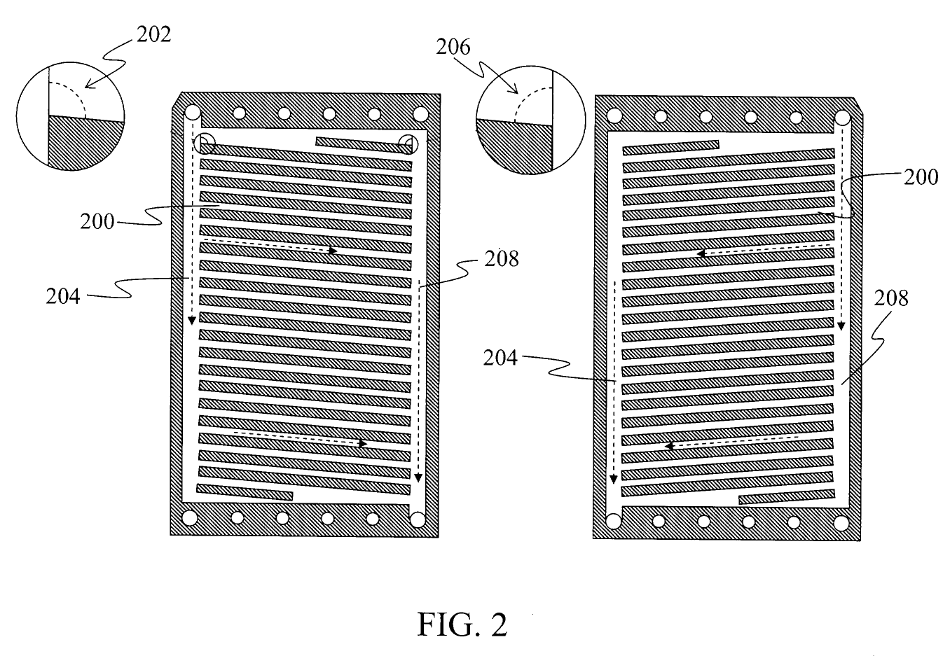

The first plate 100 and the second plate 102 are of substantially the same size and shape and are positioned for substantial overlap. While the peripheral fluid distribution channels 108a of the first plate and the peripheral fluid distribution channels 108b of the second plate are depicted as having a flow direction substantially perpendicular to the used fluid flow channels, this need not be the case. Rather it is anticipated that the peripheral fluid distribution channels could take any number of angles. For instance, in another embodiment of the present invention, as set forth in FIG. 2, the peripheral fluid distribution channels 200 form obtuse angles 202 with the fluid flow channels 204 and correspondingly acute angles 206 with the used fluid flow channels 208.

In another embodiment the peripheral fluid distribution channels are all of substantially the same cross-sectional area and each has a flow constrictor configured to control fluid flowrate and thus maximize heat flux homogeneity across the surface of the plate. It is anticipated that the constrictors would result in creating the most restrictive constrictions on the peripheral fluid distribution channels most near the fluid delivery channel and least restrictive constrictions would find application most near the used fluid return channel.

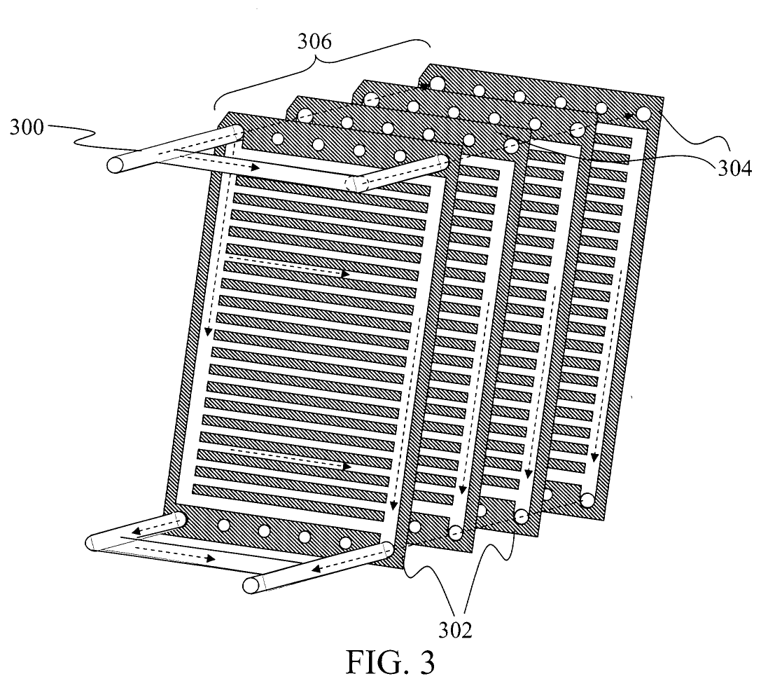

In another embodiment of the present invention it is envisioned that a fuel cell or other device requiring thermal management will be placed between the plates. Further it is envisioned that multiple sets of plates may be layered together as depicted in FIG. 3. In such an embodiment the fluid delivery channel 300 delivers fluid to a first side of the odd numbered plates 302 and on a second side of even numbered plates 304. In this manner thermal inhomogeneities are further minimized because of the alternating plate structure of the stack 306. No significance should be attached to the order of the plates, a first plate is fully interchangeable with a second plate, so long as the order is alternated. Alternating the order is desirable because a small thermal gradient will usually exist across the plate and the alternating of the plates homogenizes the gradient, therby resulting in the substantial elimination of the gradient. For ease of use, the plates may be marked so as to enable a user to readily assemble a stack with alternating plates. As is readily apparent from the views of the plates, the plates are substantially identical, only the flow direction is reversed. In this embodiment the odd numbered plates 302 are cropped, and the right edges of the even numbered plates 304 are similarly cropped on the left. Thus, as the terms “first” and “second” are arbitrary as used herein with reference to the plates, and should not be accorded any significance. The thermal control fluid outlet channel delivers the fluid away from the inventive apparatus. It is anticipated that one or more layers of proton exchange membrane fuel cells could be placed between the plates. Additionally any device requiring a high degree of thermal homogeneity could be used with this embodiment.

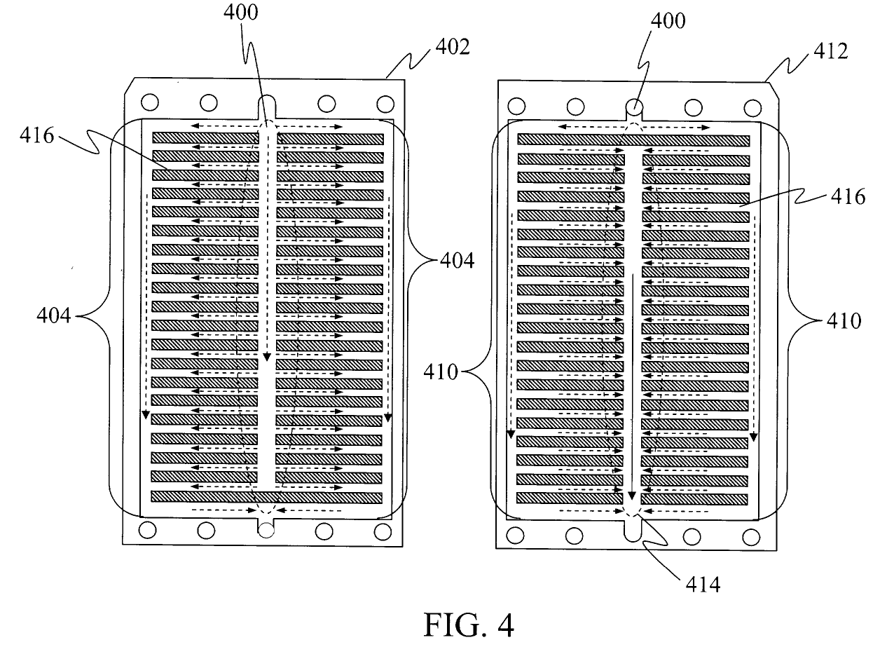

In another embodiment, depicted in FIG. 4, the first portion 400 of the first plate 402 is the middle of the first plate 402 and the second portions 404 of the first plate 402 are at the perimeter of the first plate 402. Further, the second portion 410 of the second plate 412 is at the perimeter of the second plate 412 and the first portion 414 of the second plate 412 is the middle of the plate. Thus when fluid is introduced into the first plate 402 it initially flows into the first portion 400 of the first plate 402 and then flows toward the second portions 404 of the first plate 402. Conversely, in the second plate 412, the fluid initially enters to the perimeter or second portion 410 and then flows toward the first portion 414 or center of the plate. As was stated earlier, it is anticipated that the peripheral fluid distribution channels 416 will have an angle that is optimally adjusted for the type of fluid utilized and the desired flow pattern.

In another embodiment of the present invention, all of the channels in the thermal management apparatus have substantially circular cross-sections. The choice of the shape of the channels will depend on manufacturing considerations and the properties of the fluid selected. The choice of material for the plates can vary widely, and is dependant on the type of fluid utilized and desired properties of the apparatus. For instance copper and aluminum make good candidates if a high degree of thermal conductivity is desired, conversely other materials may be more appropriate in other applications.

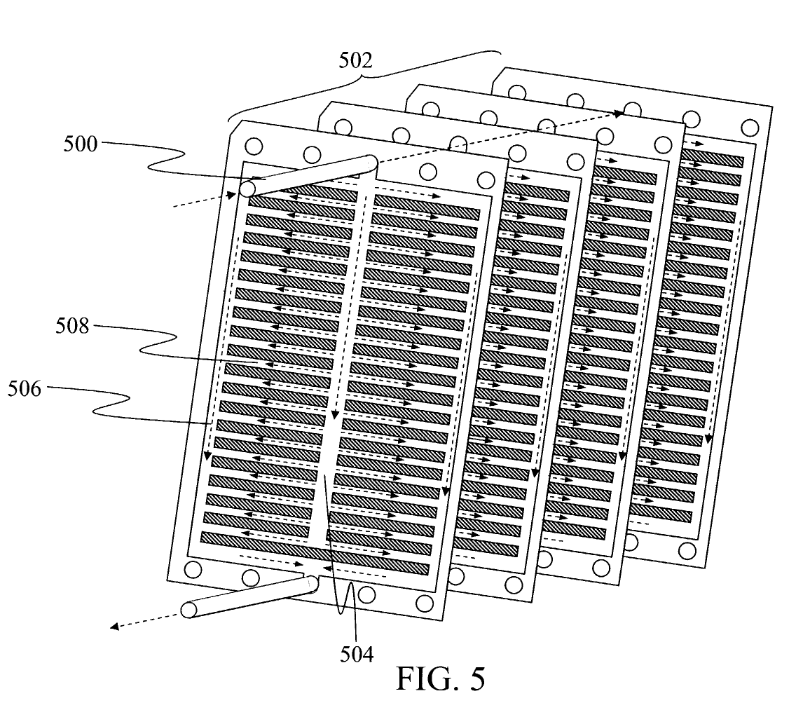

In another embodiment of the present invention, a fuel cell or other device requiring thermal management will be placed between the plates. Further it is envisioned that multiple sets of plates may be layered together as depicted in FIG. 5. In such an embodiment the fluid delivery channel 500 delivers fluid to all the plates 502. In this embodiment, the fluid is delivered to the centers or first portions 504 of all the plates. The plates alternately allow the fluid to flow from the first portion 504 toward the perimeter or second portion 506 through the peripheral fluid distribution channels 508. The adjacent plate initially forces the fluid to the perimeter and then toward the center or first portion 504. In this manner, thermal inhomogeneities are further minimized because of the alternating plate structure of the plates 502. It is anticipated that one or more layers of proton exchange membrane fuel cells could be placed between the plates.

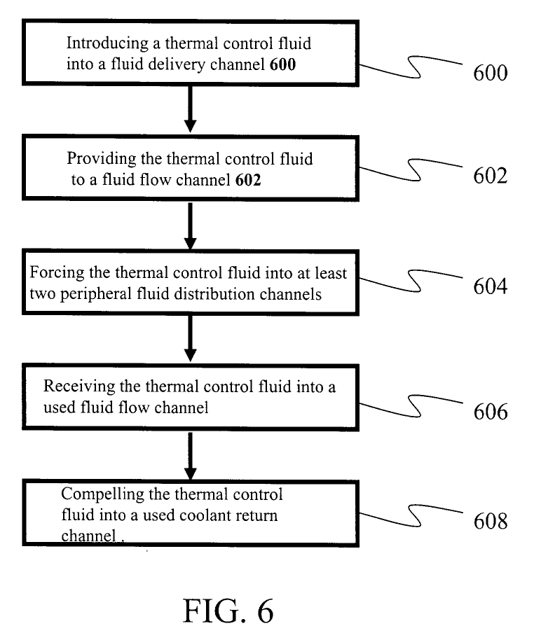

Another embodiment of the present invention, depicted in FIG. 6, provides thermal management method comprising the steps of introducing 600 a thermal control fluid into a fluid delivery channel. The thermal control fluid may take the form of any number of liquids or gases. Because liquids generally have superior material properties it is anticipated that liquid phase fluids will be employed most commonly. The next step is providing 602 the thermal control fluid to a fluid flow channel. This channel may be physically within the apparatus or immediately adjacent to the apparatus. In the third step, the thermal control fluid is forced 604 into a plurality of peripheral fluid distribution channels. The channels are configured to optimize uniform flow and minimize pressure drop. In the fourth step, the thermal control fluid is received 606 by the used fluid flow channel, which generally will run parallel to the fluid flow channel. Finally the thermal control fluid is compelled 608 into a used coolant return channel. From the used coolant return channel, the fluid may be recirculated, disposed of, processed in some way, or some combination thereof. In another embodiment of the method, heat flux homogeneity is maximized by utilizing peripheral fluid distribution channels of substantially the same cross sectional area and equipping each peripheral fluid distribution channel with a flow constrictor configured to control fluid flowrate and thereby homogenize heat flux across the plate. In yet another embodiment fluid is directed, alternately, to either a first portion or second portion of a plurality of plates. In one such embodiment the thermal control fluid of a first plate may be introduced into to the center of the first plate and into the perimeter of the second plate.

1. A thermal management apparatus including:
a first plate comprising:
i. a fluid delivery channel having cross sectional area configured to deliver a fluid to a fluid flow channel;
ii. a plurality of peripheral fluid distribution channels having an at least one cross sectional area and configured to receive fluid from the fluid flow channel and transport the fluid substantially from a first portion of the first plate to a second portion of the first plate and into a used fluid flow channel having a third cross sectional area; and
iii. a used fluid return channel having a fourth cross sectional area configured to receive fluid from the used fluid flow channel; and
a second plate comprising
i. a fluid delivery channel having a cross sectional area configured to deliver a fluid to a fluid flow channel;
ii. a plurality of peripheral fluid distribution channels having at least one cross sectional area and configured to receive fluid from the fluid flow channel and transport the fluid substantially from a second portion of the second plate to a first portion of the second plate and into a used fluid flow channel having a third cross sectional area; and
iii. a used fluid return channel configured to receive fluid from the used fluid flow channel;
wherein the first and second plates are of substantially the same size and shape and are positioned for substantial overlap and optionally allow for the placement of a device between said first plate and said second plate.

2. A thermal management apparatus as in claim 1, wherein all the peripheral fluid distribution channels form obtuse angles with the fluid flow channels and form correspondingly acute angles with the used fluid flow channels.

3. A thermal management apparatus as in claim 1, wherein the peripheral fluid distribution channels in the first plate and in the second plate are substantially parallel to each other and are substantially perpendicular to the fluid flow channel in the first plate and in the second plate.

4. A thermal management apparatus as in claim 1, wherein the peripheral fluid distribution channels, in the aggregate, have an cross sectional area less than the cross sectional area of the fluid distribution channels.

5. A thermal management apparatus as in claim 1, wherein the peripheral fluid distribution channels in the first plate and in the second plate have a plurality of cross sectional areas such that the heat flux per unit area is substantially similar across the entire plate.

6. A thermal management apparatus as in claim 1, wherein the peripheral fluid distribution channels are all of substantially the same size and each has a flow constrictor configured to control fluid flowrate such that the heat flux per unit area is substantially similar across the entire plate.

7. A thermal management apparatus as in claim 6, wherein the flow is most constricted nearest the fluid delivery channel, and least constricted farthest from the fluid delivery channel.

8. A thermal management apparatus as in claim 1, wherein the first portion of the first plate is the middle of the first plate and wherein the second portion of the first plate is the perimeter of the first plate; and
wherein the second portion of the second plate is near the perimeter of the second plate and the first portion of the second plate is the middle of the second plate.

9. A thermal management apparatus as in claim 8, wherein the fluid delivery channel enters the plates substantially a the center of the plates.

10. A thermal management apparatus as in claim 8, wherein the fluid delivery channel enters the plates at the perimeter of the plates; and
a first fluid delivery channel feeds the first plate; and
a second fluid delivery channel feeds the second plate.

11. A thermal management apparatus as in claim 1, wherein the cross-sectional area of the used fluid flow channels;
i. is at least as large as the cross sectional areas of the fluid flow channels; and
ii. is at least as large as the aggregate of the peripheral fluid distribution channels.

12. A thermal management apparatus as in claim 1, wherein all the channels have a substantially circular cross-section.

13. A thermal management apparatus as in claim 1, wherein the first and second plates are constructed of either aluminum or copper.

14. A method for controlling the temperature of an object comprising the steps of:
providing a first plate; and
i. introducing a thermal control fluid into a fluid delivery channel;
ii providing the thermal control fluid to a first fluid flow channel at a first portion of the first plate;
iii. forcing the thermal control fluid into a a plurality of first peripheral fluid distribution channels toward a second portion of a first plate;
iv. directing the thermal control fluid into a first used fluid flow channel;
v. compelling the thermal control fluid into a first used coolant return channel; and
providing a second plate; and
vi. introducing a thermal control fluid into a second fluid delivery channel;
vii providing the thermal control fluid to a second fluid flow channel at a second portion;
viii. forcing the thermal control fluid into a plurality of peripheral fluid distribution channels toward a first portion of a second plate;
ix. directing the thermal control fluid into a second used fluid flow channel; and
x. compelling the thermal control fluid into a second used coolant return channel.

15. A method for controlling the temperature of an object as set forth claim 14, wherein the thermal control fluid forced into the first peripheral fluid distribution channels travels at an obtuse angle relative to the first fluid delivery channel and at a correspondingly acute angle relative to the first used fluid flow channel.

16. A method for controlling the temperature of an object as set forth claim 14, wherein the plurality of peripheral fluid distribution channels are substantially parallel to each other and are substantially perpendicular to the first fluid flow channel and the first used fluid flow channel.

17. A method for controlling the temperature of an object as set forth claim 14, wherein the first peripheral fluid distribution channels, in the aggregate, have a cross sectional area less than the cross sectional area of the first fluid distribution channels.

18. A method for controlling the temperature of an object as set forth claim 14, wherein by adjusting the cross sectional areas of the first peripheral fluid distribution channels the heat flux per unit area from the first peripheral fluid distribution channels is substantially similar across the entire plate.

19. A method for controlling the temperature of an object as set forth claim 14, wherein heat flux homogeneity is maximized by utilizing first peripheral fluid distribution channels of substantially the same size and equipping each first peripheral fluid distribution channel with a flow constrictor configured to control fluid flowrate and thereby homogenize heat flux per unit area across the plate.

20. A method for controlling the temperature of an object as set forth claim 14, wherein fluid directed to the first portion of the first plate is delivered to the middle of the first plate and wherein fluid directed to the second portion of the first plate is delivered to a channel at the perimeter of the first plate and wherein the fluid directed to the second portion of the second plate is delivered to at least one channel at the perimeter of the second plate, and fluid directed to the first portion of the second plate is directed to the middle of the second plate.
